(19) United States
(12) Patent Application Publication
(10) Pub. No.: US 2026/0220076 A1
(43) Pub. Date: Jul. 30, 2026

(54) IMAGE PROCESSING DEVICE

(71) Applicant: BROTHER KOGYO KABUSHIKI KAISHA, Nagoya (JP)

(72) Inventor: Takayuki SUZUKI, Nagoya (JP)

(73) Assignee: BROTHER KOGYO KABUSHIKI KAISHA, Nagoya (JP)

(21) Appl. No.: 19/453,380

(22) Filed: Jan. 20, 2026

(30) Foreign Application Priority Data
Jan. 24, 2025 (JP) 2025-010333

(51) Int. Cl. G06F 15/163; G06V 30/41

(52) U.S. Cl. CPC G06F 15/163; G06V 30/41

(57) ABSTRACT

An image processing device includes a first CPU, a second CPU, a reading engine, and a user interface. The first CPU is configured to control the user interface. The second CPU is configured to control the reading engine. In a case where the image processing device is powered on the first CPU executes first activation processing that is activation processing of the first CPU; the second CPU executes second activation processing that is activation processing of the second CPU including initial control of the reading engine; in a case where the second activation processing is completed, the second CPU is configured to cause the reading engine to perform reading in accordance with an instruction from the first CPU.

### REFERENCE TO RELATED APPLICATIONS

This application claims priority from Japanese Patent Application No. 2025-010333 filed on January 24, 2025. The entire content of the priority application is incorporated herein by reference.

### BACKGROUND ART

There are techniques for processing during activation of an image processing device. For example, a related art discloses an image input and output system including an image processing device, in which device configuration information is saved when activation is completed, and during re-activation, the saved device configuration information is used to start activation processing before receiving a response from hardware.

In recent years, a configuration is known in which an image processing device includes at least two CPUs, one CPU is mainly used for controlling a system, and the other CPU is used for controlling an image processing engine. In such an image processing device, processing during activation is performed for each CPU, and shortening of activation time which is time until the processing during activation is completed becomes a problem. The related art does not disclose processing during activation in the image processing device having at least two CPUs, and there is room for improvement.

### SUMMARY

An image processing device includes a first CPU, a second CPU, a reading engine, and a user interface. The first CPU is configured to control the user interface. The second CPU is configured to control the reading engine. The first CPU executes first activation processing that is activation processing of the first CPU. The second CPU executes second activation processing that is activation processing of the second CPU including initial control of the reading engine. In a case where the second activation processing is completed, the second CPU is configured to cause the reading engine to perform reading in accordance with an instruction from the first CPU. In a case where the first activation processing is completed, the first CPU confirms whether the second activation processing executed by the second CPU is completed, and the first CPU is configured not to allow at least an operation related to reading among operations on the user interface to be received until completion of the second activation processing is confirmed and to allow the operation related to reading to be received, in a case where the completion of the second activation processing is confirmed. In a case where the first CPU sends a reading instruction to the second CPU in accordance with the operation related to reading after the operation related to reading on the user interface is allowed to be received, the second CPU causes the reading engine to perform reading in accordance with the reading instruction from the first CPU.

### BRIEF DESCRIPTION OF DRAWINGS

FIG. 1 is a block diagram illustrating a schematic configuration of an MFP according to an embodiment.

FIG. 2 is a diagram illustrating an example of a reading range implemented by an image reading configuration.

FIG. 3 is a flowchart illustrating a procedure of main CPU activation processing.

FIG. 4 is a flowchart illustrating a procedure of sub-CPU monitoring processing.

FIG. 5A is a diagram illustrating an example of a home screen.

FIG. 5B is a diagram illustrating an example of the home screen.

FIG. 5C is a diagram illustrating an example of the home screen.

FIG. 6 is a flowchart illustrating a procedure of first sub-CPU activation processing.

FIG. 7 is a flowchart illustrating a procedure of second sub-CPU activation processing.

FIG. 8A is a diagram illustrating an example of a message screen.

FIG. 8B is a diagram illustrating an example of the message screen.

FIG. 9 is a flowchart illustrating a procedure of standby processing.

FIG. 10 is a flowchart illustrating a procedure of recovery processing.

FIG. 11 is a diagram illustrating an example when a CIS is not in the vicinity of a reference position HP.

### DESCRIPTION

Hereinafter, an embodiment embodying an image processing device will be described in detail with reference to the accompanying drawings. The present specification discloses a multi function device (hereinafter, referred to as an "MFP") having a function of reading image.

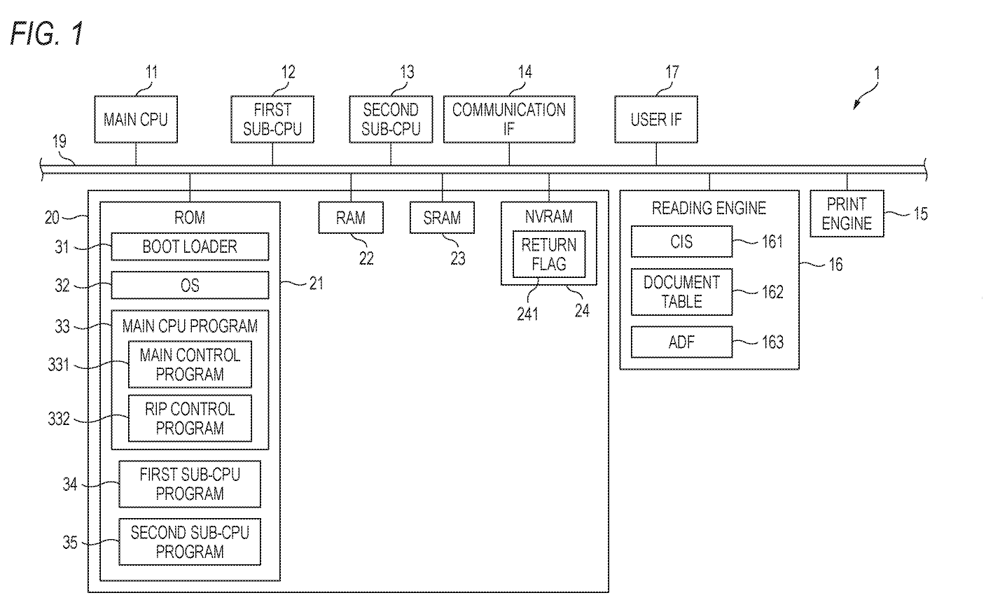

As illustrated in FIG. 1, an MFP 1 according to the present embodiment includes a main CPU 11, a first sub-CPU 12, a second sub-CPU 13, a communication interface (hereinafter, referred to as "communication IF") 14, a print engine 15, a reading engine 16, and a user interface (hereinafter, referred to as "user IF") 17, which are connected to a bus 19. The main CPU 11 is an example of a first CPU, the second sub-CPU 13 is an example of a second CPU, and the first sub-CPU 12 is an example of a third CPU.

The main CPU 11, the first sub-CPU 12, and the second sub-CPU 13 are separate pieces of hardware. The main CPU 11, the first sub-CPU 12, and the second sub-CPU 13 may be mounted on one chip. That is, the MFP 1 may include a system on a chip (SoC) on which the main CPU 11, the first sub-CPU 12, and the second sub-CPU 13 are mounted.

The MFP 1 further includes a memory 20 including a ROM 21, a RAM 22, an SRAM 23, and an NVRAM 24, which are connected to the bus 19. The ROM 21 and the NVRAM 24 are nonvolatile memories, and the RAM 22 and the SRAM 23 are volatile memories. The ROM 21 is an example of a first memory, and the RAM 22 is an example of a second memory. The memory 20 may be mounted on the SoC on which the main CPU 11 is mounted.

The main CPU 11, the first sub-CPU 12, and the second sub-CPU 13 is configured to execute various processing in accordance with a program read from the memory 20 or based on a user operation. The main CPU 11 mainly performs system control such as managing files and tasks of the MFP 1 and controlling of the user IF 17 and the communication IF 14. The first sub-CPU 12 mainly controls the print engine 15. The second sub-CPU 13 mainly controls the reading engine 16. The memory 20 stores various programs and various data. The memory 20 is used as a work area when executing various processing.

An example of the memory 20 is not limited to a ROM, a RAM, an HDD, and the like incorporated into the MFP 1, and may be a storage medium readable and writable by the computer. For example, an external memory such as a USB memory or an HDD connected to the MFP 1, or a memory or an HDD provided in a device connected to the MFP 1 via the communication IF 14 is also an example of the memory 20. Buffers included in the main CPU 11, the first sub-CPU 12, and the second sub-CPU 13 are also examples of the memory.

The computer-readable storage medium is a non-transitory medium. The non-transitory medium also includes a recording medium such as a CD-ROM or a DVD-ROM, in addition to the above examples. The non-transitory medium is also a tangible medium. Meanwhile, an electric signal conveying a program downloaded from a server or the like on the Internet is a computer-readable signal medium, which is a kind of computer-readable medium, but is not included in the non-transitory computer-readable storage medium.

FIG. 1 illustrates the MFP 1 in a power-off state. In this state, each program or data is stored in the ROM 21, and nothing is stored in the RAM 22 or the SRAM 23. The NVRAM 24 is configured to store a return flag 241. The NVRAM 24 is a storage area accessible from any of the main CPU 11, the first sub-CPU 12, and the second sub-CPU 13. The return flag 241 will be described later.

The ROM 21 of the memory 20 is configured to store a boot loader 31, an operating system (hereinafter, referred to as "OS") 32, a main CPU program 33, a first sub-CPU program 34, and a second sub-CPU program 35. Each program is compressed and stored except for a part of the boot loader 31. The boot loader 31 is an example of a boot program. The OS 32 and the main CPU program 33 are examples of a system program. The second sub-CPU program 35 is an example of a reading program. The OS 32 is, for example, a Linux kernel.

The boot loader 31, the OS 32, and the main CPU program 33 are programs executed by the main CPU 11. The main CPU program 33 is a program group that operates on the OS 32, and includes a main control program 331 and a raster image processor (RIP) control program 332. The main control program 331 is a program for controlling the units of the MFP 1 other than the print engine 15 and the reading engine 16, including the user IF 17 and the communication IF 14. The RIP control program 332 is a program for performing RIP processing on image data to be printed and generating image data in a raster format based on the image data.

The first sub-CPU program 34 is a program executed by the first sub-CPU 12. The first sub-CPU program 34 includes a program for controlling the print engine 15. The first sub-CPU program 34 may include, for example, a program for controlling power supplied to units of the MFP 1 including the print engine 15 in a power saving state.

The second sub-CPU program 35 is a program executed by the second sub-CPU 13. The second sub-CPU program 35 includes a program for controlling the reading engine 16. The second sub-CPU program 35 includes an OS for the second sub-CPU 13 separately from the OS 32. In the MFP 1 according to the present embodiment, the first sub-CPU program 34 does not include an OS.

The communication IF 14 includes hardware for communicating with an external device such as a personal computer. The MFP 1 may include a plurality of communication IF 14 corresponding to a plurality of communication standards. The user IF 17 is, for example, a touch panel, and includes hardware implemented to display a screen for notifying a user of information, and hardware implemented to receive an operation from the user.

The print engine 15 includes, for example, a configuration for printing an image on a print medium such as a sheet by an electrophotographic method using toner. An image forming method of the print engine 15 may be an inkjet method. The MFP 1 according to the present embodiment may include the print engine 15 that is capable of executing color printing using a multicolor colorant, or may include the print engine 15 that performs only monochrome printing using a monochrome colorant.

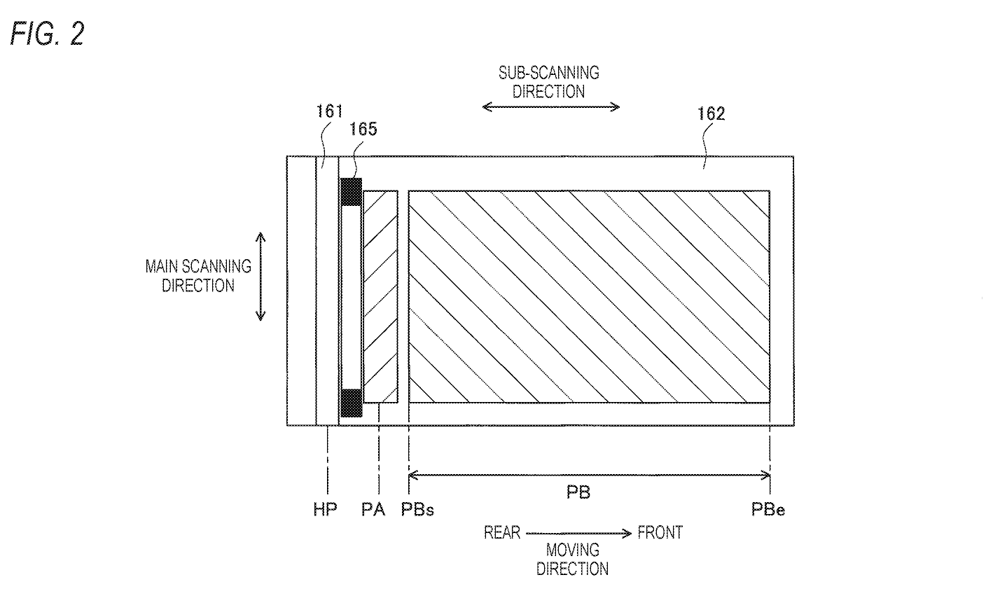

The reading engine 16 includes a contact image sensor (CIS) 161, a document table 162, and an automatic document feeder (hereinafter, referred to as "ADF") 163 configured to automatically feed a document. The reading engine 16 of the MFP 1 is configured to read an image of a document in, for example, an area indicated by diagonal lines in FIG. 2. FIG. 2 is a diagram illustrating a positional relation between the CIS 161 and the document table 162 except for the ADF 163.

The CIS 161 includes a plurality of reading elements for optically reading an image of a document. The CIS 161 is an example of a reading sensor. The reading elements of the CIS 161 are arranged, for example, in a main scanning direction indicated by a vertical direction in FIG. 2. The CIS 161 is movable in a sub-scanning direction indicated as a left-right direction in FIG. 2. The MFP 1 is configured to generate reading data based on a reading result obtained by reading an image of a document by the CIS 161. The CIS 161 may be a device configured to execute color reading for reading an image of a document as a color image or a device capable of executing only monochrome reading.

The document table 162 includes a transparent plate-shaped contact glass provided to be integrally fixed to a housing of the MFP 1. The document table 162 is also referred to as a flat bed (hereinafter, referred to as "FB"). The MFP 1 according to the present embodiment is configured to execute both FB reading for reading an image of a document placed on the document table 162 and ADF reading for reading an image of a document fed by the ADF 163.

When executing the ADF reading, the MFP 1 stops the CIS 161 at a stop position PA for ADF reading, feeds the document placed on a document tray of the ADF 163 one by one by the ADF 163, and executes feeding of the document and reading of an image of the document in parallel. The stop position PA for ADF reading is an example of a reading location. The MFP 1 may be configured to execute double-sided reading or may be configured to execute only single-sided reading by the ADF reading.

When executing the FB reading, the MFP 1 first positions the CIS 161 at a reading start position PBs for FB reading. Then, as indicated as a moving direction in FIG. 2, the MFP 1 executes the movement of the CIS 161 in the sub-scanning direction and the reading of an image of a document placed on the document table 162 in parallel. The MFP 1 is configured to read an image from the reading start position PBs to a reading end position PBe at most according to a size of a document by the FB reading. Each position of the CIS 161 within a range from the reading start position PBs to the reading end position PBe is an example of the reading location. Hereinafter, in the sub-scanning direction, the right side in FIG. 2 is also referred to as the front, and the left side in FIG. 2 is also referred to as the rear.

After the ADF reading or the FB reading ends, the MFP 1 moves the CIS 161 rearward and stops the CIS 161 at a predetermined reference position HP. The reference position HP is an example of a standby location. The reference position HP is outside a range in which reading is performed by the ADF reading or the FB reading, and is a position behind the stop position PA for ADF reading and the reading start position PBs for FB reading. In the MFP 1, the reading start position PBs for FB reading is provided in front of the stop position PA for ADF reading. The MFP 1 can appropriately stop the CIS 161 at the reference position HP by detecting a black-and-white tape 165 attached to a back surface of the document table 162 outside the reading range.

Next, the operation of the MFP 1 according to the present embodiment will be described with reference to flowcharts. The following processing basically indicates processing of each CPU according to commands written in programs. That is, the processing such as "determination", "extraction", "selection", "calculation", "determination", "specification", "acquisition", "reception", and "control" to be described below represents the processing of each CPU. The processing executed by each CPU also includes hardware control using API of the OS. In the present specification, the description of the OS is omitted, and an operation of each program is described. That is, in the following description, the description that "a program B controls hardware C" may refer to "the program B controls the hardware C, using the API of the OS". In addition, the processing of each CPU according to the commands written in the programs may be described in omitted words. For example, the processes of the CPU may be described as "the CPU performs". In addition, the processing of each CPU according to the commands written in the programs may be described in words in which the CPU is omitted, such as "the program A performs".

In addition, in the present specification, "notification", "alert", "notifying", "reply", "response", "answer", and the like are not limited to a meaning of transmission of information to a person, and are also used as words meaning communication or exchange of information between devices or between components in a device. The configuration in the device includes software.

The term "acquisition" is used as a concept indicating that a request is not essential. That is, processing of receiving data without a request from each CPU is also included in a concept indicating that "the CPU acquires data". In addition, the term "data" in the present specification is represented by a computer-readable bit string. Furthermore, data having substantially the same meaning and different formats are treated as the same data. The same applies to "information" in the present specification. In addition, the term "request" or "instruct" is a concept indicating that information indicating that a request is being made or information indicating that an instruction is being given is output to a partner. In addition, the information indicating that a request is being made or the information indicating that an instruction is being given is simply referred to as a "request" or "instruction".

According to each CPU, processing of determining whether information A indicates that it is a matter B may be conceptually described as "determining whether it is the matter B, based on the information A". According to each CPU, processing of determining whether the information A indicates that it is the matter B or a matter C may be conceptually described as "determining whether it is the matter B or the matter C, based on the information A".

In the present specification, a setting item may be simply referred to as "setting". A setting value may be simply referred to as "setting". The setting value may be described as a "parameter". Furthermore, storing the setting value in a memory or the like may be simply referred to as "setting". An operation for setting or input for setting may be simply referred to as "setting".

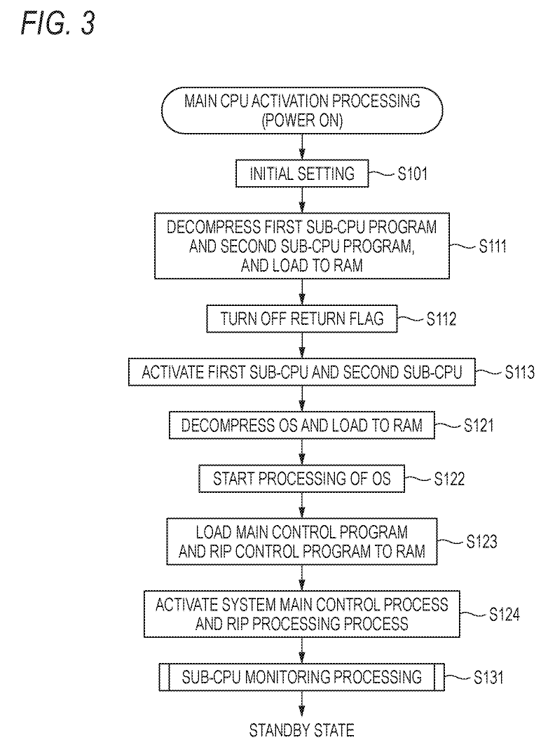

The MFP 1 according to the present embodiment starts execution of predetermined processing for activation in a case where a power-off state is changed to a power-on state or in a case in which a reset instruction is received due to a user operation. Specifically, the MFP 1 is statically set in the hardware so that the main CPU 11 starts to operate from the head of the boot loader 31 when the MFP 1 is powered on. A procedure of main CPU activation processing will be described with reference to the flowchart illustrated in FIG. 3. The main CPU activation processing is executed by the main CPU 11 of the MFP 1 in response to activation by power-on.

First, the main CPU 11 performs initial setting (S101). Specifically, the main CPU 11 starts the operation from the head of the un-compressed part of the boot loader 31 stored in the ROM 21, decompresses the compressed part of the boot loader 31, and loads the decompressed part into the SRAM 23. Further, the main CPU 11 operates in accordance with the boot loader 31 written in the SRAM 23. The main CPU 11 performs operation setting of the RAM 22 in order to load a program to the RAM 22, for example.

Then, after the initial setting ends, the main CPU 11 decompresses the first sub-CPU program 34 and the second sub-CPU program 35 stored in the ROM 21, and loads the programs to predetermined storage locations, respectively (S111).

Further, the main CPU 11 turns off the return flag 241 provided in the NVRAM 24 (see FIG. 1) (S112). The return flag 241 is a flag for the main CPU 11 and the second sub-CPU 13 to share information indicating whether the activation processing of the second sub-CPU 13 to be executed later is processing started based on power-on or processing started by return from a deep sleep state. The off state of the return flag 241 indicates that the current processing is started not by the return from the deep sleep state but by the power-on or reset instruction.

The deep sleep state is a state where power consumption is reduced by limiting the supply of power to the print engine 15 and the reading engine 16 although the power is not turned off. The deep sleep state is a state where power consumption is smaller than that in a standby state where printing or reading can be executed. The MFP 1 can execute printing or reading after returning from the deep sleep state to the standby state.

In the deep sleep state, the MFP 1 is configured to receive data via the communication IF 14 and receive a user operation on the user IF 17. The MFP 1 returns from the deep sleep state to the standby state, for example, when receiving data or receiving a user operation in the deep sleep state. In addition, the MFP 1 can transition to the deep sleep state in a case in which a predetermined time elapses in a standby state without performing any of reception of various data, reception of a user operation on the user IF 17, and execution of processing such as reading or printing.

When the loading of each program ends, the main CPU 11 releases the reset of the first sub-CPU 12 and the second sub-CPU 13 in accordance with the boot loader 31, and activates the first sub-CPU 12 and the second sub-CPU 13 (S113). Both the first sub-CPU 12 and the second sub-CPU 13 can operate independently of the main CPU 11. The first sub-CPU 12 and the second sub-CPU 13 start processing for activation independently of each other in response to the reset release in S113. Processing executed by the first sub-CPU 12 and the second sub-CPU 13 will be described later.

After activating the first sub-CPU 12 and the second sub-CPU 13, the main CPU 11 further executes an operation according to the boot loader 31. After S113, the main CPU 11 decompresses the OS 32 stored in the ROM 21 and loads the OS into the RAM 22 (S121). When the loading of the OS 32 is completed, the main CPU 11 ends the operation according to the boot loader 31 and starts processing based on the OS 32 (S122). The processing based on the OS 32 started in S122 is an example of first activation processing. As a result, the MFP 1 executes the activation processing executed by the OS 32, the activation processing executed by the first sub-CPU 12, and the activation processing executed by the second sub-CPU 13, which are executed by the main CPU 11, in parallel.

The main CPU 11 decompresses the main control program 331 and the RIP control program 332 included in the main CPU program 33 and respectively loads them into the RAM 22 (S123). Further, the main CPU 11 activates a system main control process based on the main control program 331, and activates a RIP processing process based on the RIP control program 332 (S124). The system main control process and the RIP processing process are resident processes according to each application program operating on the OS 32. There may be a resident process in addition to the system main control process and the RIP processing process, and the main CPU 11 may activate other processes.

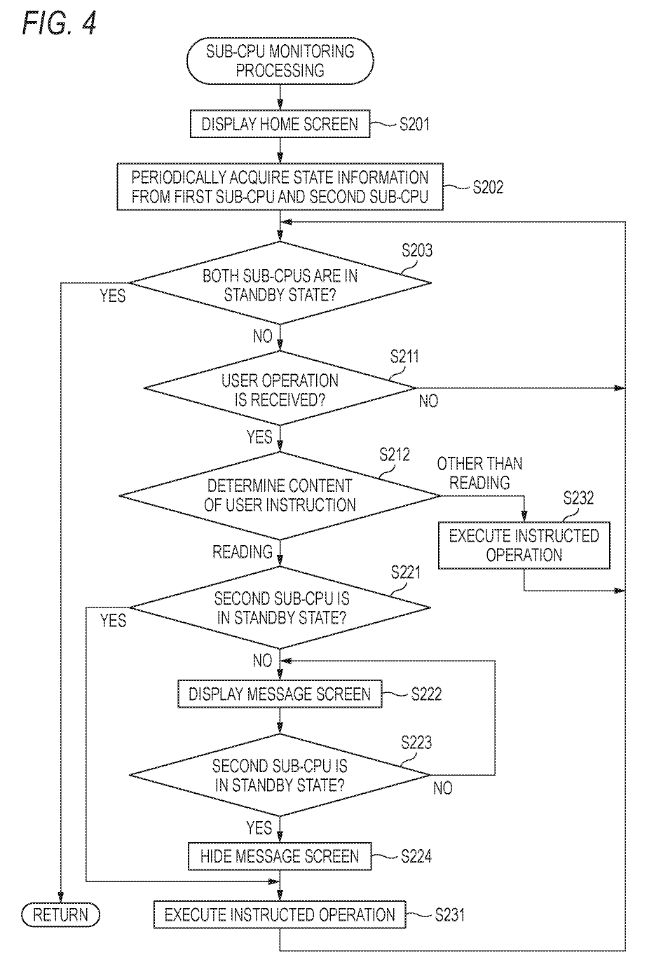

In initial processing according to the main CPU program 33, in a case where the initialization of the user IF 17 and the communication IF 14 and the activation of various application processes ends, the main CPU 11 executes sub-CPU monitoring processing (S131). The sub-CPU monitoring processing is processing of monitoring an operating state of the first sub-CPU 12 and an operating state of the second sub-CPU 13. A procedure of the sub-CPU monitoring processing will be described with reference to the flowchart illustrated in FIG. 4.

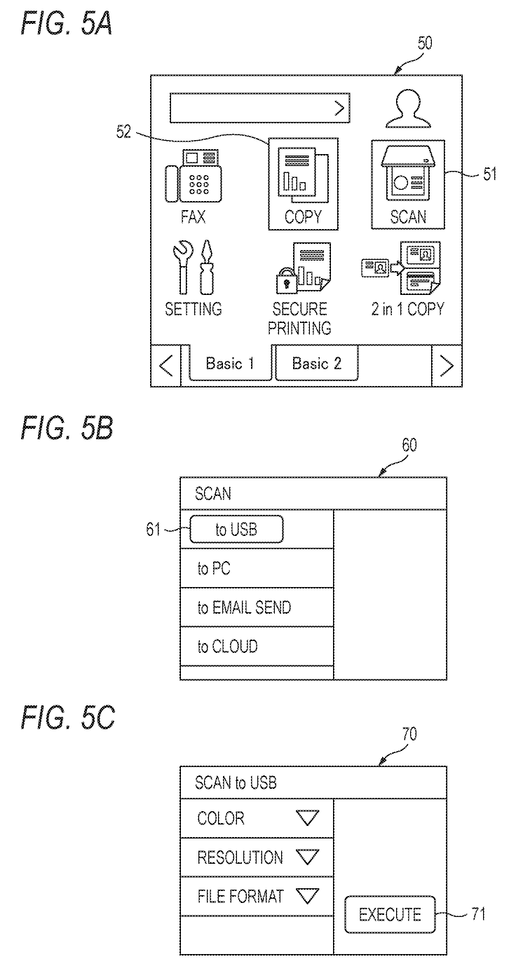

In the sub-CPU monitoring processing, the main CPU 11 causes the user IF 17 to display a home screen (S201). For example, as illustrated in FIG. 5A, the main CPU 11 causes the user IF 17 to display a home screen 50 including a plurality of icons such as a scan icon 51 and a copy icon 52. The scan icon 51 and the copy icon 52 are icons for receiving operations related to reading, and are examples of specific icons.

Then, the main CPU 11 acquires information indicating the state of the first sub-CPU 12 and information indicating the state of the second sub-CPU 13, respectively (S202). The first sub-CPU 12 and the second sub-CPU 13 execute respective activation processing based on the reset release by the main CPU 11 (S113 in FIG. 3). The main CPU 11 confirms whether both the first sub-CPU 12 and the second sub-CPU 13 enter the standby state based on the information acquired in S202 (S203).

For example, the main CPU 11 may periodically inquire of the first sub-CPU 12 and the second sub-CPU 13 to acquire and determine respective state information. Further, for example, the main CPU 11 may confirm whether the first sub-CPU 12 and the second sub-CPU 13 are in the standby state based on the information stored in the memory 20. For example, when the first sub-CPU 12 and the second sub-CPU 13 are in the standby state, the information indicating that they are in the standby state may be made valid, for example, by writing the information in the memory 20. Further, for example, when the first sub-CPU 12 and the second sub-CPU 13 are in the standby state, the information stored in the memory 20 indicating that they are not in a standby state may be made invalid, for example, by deleting the information.

When ending their respective activation processing and being in the standby state, the first sub-CPU 12 and the second sub-CPU 13 pass information indicating the standby state to the main CPU 11 as a response to the inquiry made in S203. Meanwhile, when not being in the standby state, the first sub-CPU 12 and the second sub-CPU 13 do not pass the information indicating the standby state to the main CPU 11 as a response to the inquiry made in S203. Here, the activation processing of the first sub-CPU 12 and the activation processing of the second sub-CPU 13 will be described.

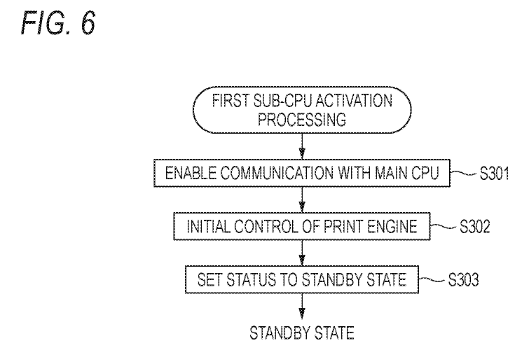

The first sub-CPU 12 executes first sub-CPU activation processing in accordance with the first sub-CPU program 34. A procedure of the first sub-CPU activation processing will be described with reference to the flowchart illustrated in FIG. 6. The first sub-CPU activation processing is executed as the reset of the first sub-CPU 12 is released in S113 in the main CPU activation processing. The first sub-CPU activation processing executed by the first sub-CPU 12 is an example of third activation processing.

The first sub-CPU 12 first enables communication with the main CPU 11 (S301). Specifically, the main CPU 11 and the first sub-CPU 12 communicate with each other using, for example, inter-CPU communication using FIFO and an interrupt. In S301, for example, the first sub-CPU 12 enables an interrupt from the main CPU 11 and registers a function for interpreting received data.

The first sub-CPU 12 further executes initial control of the print engine 15 (S302). The first sub-CPU 12 executes, for example, at least one of warm-up control including raising a temperature of a fixing device, a toner stirring operation including an operation of rotating a developing roller, a new toner cartridge check, laser light output control, and a polygon motor rotation check. In a case where the print engine 15 is of an inkjet type, the first sub-CPU 12 may preheat the ink head in S302.

In a case where the initial control of the print engine 15 ends, the first sub-CPU 12 sets its own status to the standby state (S303). In a case where state information is requested from the main CPU 11 before S303 (S202 in FIG. 4), the first sub-CPU 12 responds with information indicating that it is not in the standby state. In a case where the state information is requested from the main CPU 11 after S303, the first sub-CPU 12 responds with information indicating the standby state.

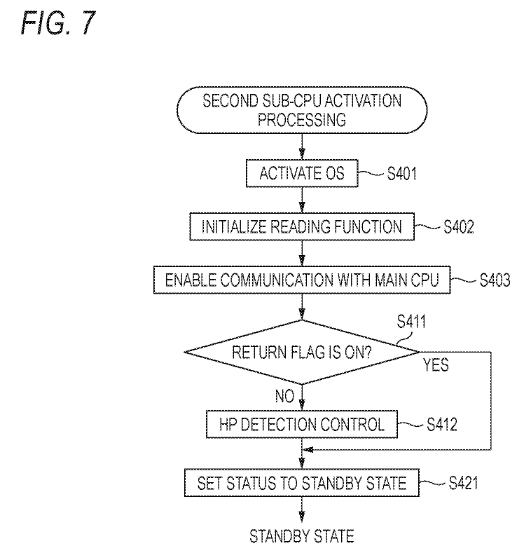

Meanwhile, the second sub-CPU 13 executes second sub-CPU activation processing in accordance with the second sub-CPU program 35. A procedure of the second sub-CPU activation processing will be described with reference to the flowchart illustrated in FIG. 7. The second sub-CPU activation processing is executed when the second sub-CPU 13 is activated by releasing the reset from a shutdown state.

The second sub-CPU 13 is shut down and powered off not only in a case where the MFP 1 is powered off but also in a case where the MFP 1 transitions to the deep sleep state. Then, also at the time of returning from the deep sleep state, the main CPU 11 releases the reset of the second sub-CPU 13. That is, the second sub-CPU 13 executes the second sub-CPU activation processing both in the case in which the reset is released in S113 of the main CPU activation processing (see FIG. 3) and in the case in which the reset is released due to recovery processing from the deep sleep state described later. The first sub-CPU 12 is not powered off even after transitioning to the deep sleep state.

In the second sub-CPU activation processing, the second sub-CPU 13 first activates the OS included in the second sub-CPU program 35 (S401). Then, the second sub-CPU 13 executes initialization for a reading function (S402). The second sub-CPU 13 performs, for example, initialization of a memory area used in the reading function and initial setting of various parameters for reading. Further, the second sub-CPU 13 enables communication with the main CPU 11 (S403). For example, the second sub-CPU 13 communicates with the main CPU 11 using the inter-CPU communication using the FIFO and the interrupt, similarly to the inter-CPU communication between the main CPU 11 and the first sub-CPU 12.

Then, the second sub-CPU 13 determines whether the return flag 241 (see FIG. 1) is ON (S411). When determining that the return flag 241 is OFF (S411: NO), the second sub-CPU 13 executes HP detection control of the reading engine 16 (S412). The HP detection control is an operation of placing the CIS 161 at the predetermined reference position HP (see FIG. 2). S412 is an example of sensor placement processing.

Specifically, in S412, the MFP 1 first moves the CIS 161 forward by a certain amount and attempts to detect the black-and-white tape 165. In a case where the CIS 161 is already positioned at the reference position HP or in the vicinity thereof, the black-and-white tape 165 can be detected by this movement. In a case where the black-and-white tape 165 can be detected, the MFP 1 stops the CIS 161 at the reference position HP by moving the CIS 161 rearward from the position of the black-and-white tape 165 by a predetermined distance. That is, in a case where the CIS 161 is at the reference position HP from the start of the HP detection control, the HP detection control is immediately completed.

Meanwhile, in a case where the black-and-white tape 165 cannot be detected by the initial certain amount of movement, the MFP 1 further moves the CIS 161 forward. For example, the MFP 1 may move the CIS 161 to a movable right end position. Thereafter, the MFP 1 moves the CIS 161 rearward, and attempts to detect the black-and-white tape 165 again.

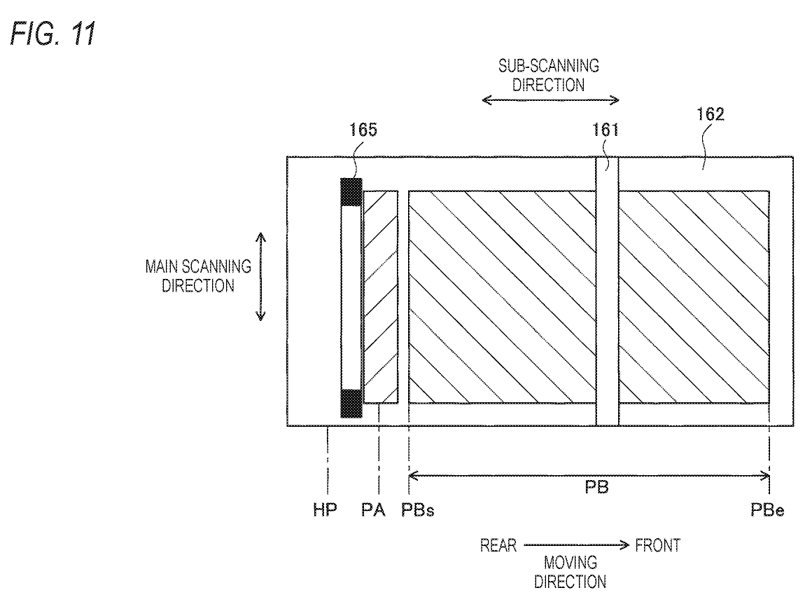

The HP detection control is control requiring a certain amount of time because it involves the movement of the CIS 161. In particular, for example, as illustrated in FIG. 11, when the CIS 161 is not in the vicinity of the reference position HP, the distance for moving the CIS 161 becomes long, and thus the time required for the HP detection control becomes long. Therefore, the time required for the HP detection control may be longer than, for example, the time required for the execution of S122 to S124 illustrated in FIG. 3, which is the activation processing executed by the main CPU 11.

In a case where the black-and-white tape 165 is detected, the MFP 1 stops the CIS 161 at the reference position HP by moving the CIS 161 by a predetermined distance from the position where the black-and-white tape 165 is detected. Meanwhile, in a case where the black-and-white tape 165 is not detected by the backward movement, the MFP 1 may determine that an error occurs or may re-execute the HP detection control. After the HP detection control of S412 ends, the second sub-CPU 13 sets its own status to the standby state (S421).

When the power is turned on, the CIS 161 may or may not be in the vicinity of the reference position HP. The reason will be described. After a job including the ADF reading or the FB reading ends, the MFP 1 moves the CIS 161 to the reference position HP, and then ends the processing of the job. That is, when the power is turned off after the processing of the job is normally ended, the CIS 161 is at the reference position HP when the power is turned on. Therefore, when being in the deep sleep state, the CIS 161 is at the reference position HP.

Although details will be described later, the main CPU 11 turns on the return flag 241 when transitioning to the deep sleep state or returning from the deep sleep state. When determining that the return flag 241 is on (S411: YES), the second sub-CPU 13 does not execute S412 and sets its own status to the standby state (S421). That is, when it is determined that the return flag 241 is on, as illustrated in FIG. 2, since the CIS 161 is at the reference position HP, the second sub-CPU 13 does not execute the HP detection control. Since the HP detection control is not executed in the second sub-CPU activation processing executed when returning from the deep sleep state, the MFP 1 can return from the deep sleep state early.

When receiving an instruction to turn off the power by an operation on a power switch, the MFP 1 positions the CIS 161 at the reference position HP and then turns off the power. However, during the execution of the FB reading or the ADF reading, or after the end of the reading and before the CIS 161 moves to the reference position HP, when the power supply is suddenly stopped due to removal of a power supply code, power failure, or the like, the CIS 161 may stop at a position other than the reference position HP. That is, as illustrated in FIG. 11, the CIS 161 may stop at a position that is not in the vicinity of the reference position HP. As described above, depending on the situation in which the power is turned off, the CIS 161 may not be placed at the reference position HP when the power is turned on, and may remain at a reading location.

When being activated by the power-on of the MFP 1, the main CPU 11 turns off the return flag 241 in S112 of the main CPU activation processing illustrated in FIG. 3 because the power-off state is unknown. Therefore, in a case where the MFP 1 is switched from the power-off state to the power-on state, the second sub-CPU 13 executes the second sub-CPU activation processing including the HP detection control. Accordingly, the MFP 1 can reliably place the CIS 161 at the reference position HP. The second sub-CPU activation processing when the return flag 241 is OFF is an example of second activation processing.

The sub-CPU monitoring processing illustrated in FIG. 4 will be described again. When determining that at least one of the first sub-CPU 12 and the second sub-CPU 13 is not in the standby state based on the information periodically acquired in S202 (S203: NO), the main CPU 11 determines whether a user operation is received (S211). Even in a case where at least one of the first sub-CPU 12 and the second sub-CPU 13 is not in the standby state, the main CPU 11 can receive an operation on the home screen 50 (see FIG. 5A to 5C) displayed in S201.

When determining that the user operation is received, (S211: YES), the main CPU 11 determines whether the instruction received by the operation is an instruction including a reading operation (S212). Specifically, for example, when receiving an operation on the scan icon 51, the copy icon 52, or the like on the home screen 50, the main CPU 11 determines that the instruction is an instruction including a reading operation.

When determining that the instruction of the user is the instruction including the reading operation (S212: reading), the main CPU 11 determines whether the second sub-CPU 13 is in the standby state (S221). When determining that the second sub-CPU 13 is in the standby state (S221: YES), the main CPU 11 executes an operation including reading based on the instruction of the user (S231). That is, when confirming the completion of the activation processing of the second sub-CPU 13, the main CPU 11 allows an operation related to reading to be received.

For example, in a case where an operation on the scan icon 51 on the home screen 50 illustrated in FIG. 5A is received, the main CPU 11 displays an output destination selection screen 60 for receiving a selection of an output destination of scan data, as illustrated in FIG. 5B, for example. The output destination selection screen 60 includes output destination selection buttons such as "to USB" 61. After generating reading data by reading an image of a document, the MFP 1 can output the generated reading data to a designated output destination.

When the selection of the output destination is received on the output destination selection screen 60, the main CPU 11 displays an execution instruction screen 70 including an execution button 71, as illustrated in FIG. 5C, for example. In the execution instruction screen 70, the main CPU 11 may be configured to receive various setting instructions related to reading. When receiving the operation on the execution button 71, the main CPU 11 instructs the second sub-CPU 13 to start the reading operation. When the second sub-CPU 13 is in the standby state, the CIS 161 is positioned at the reference position HP, and the second sub-CPU 13 can immediately move the CIS 161 to the reading location and start the reading operation.

Meanwhile, when determining that the second sub-CPU 13 is not in the standby state (S221: NO), the main CPU 11 causes the user IF 17 to display a message screen (S222), and enters a state of not receiving an operation on the user IF 17. That is, the main CPU 11 does not allow the operation related to reading to be received until the completion of the activation processing of the second sub-CPU 13 is confirmed.

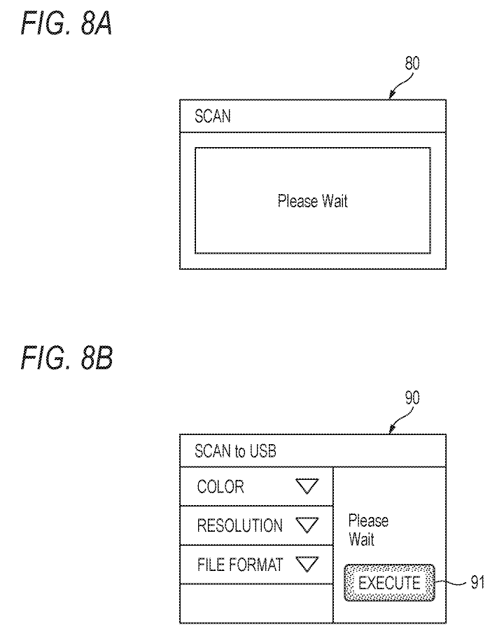

In a case where an operation on the scan icon 51 of the home screen 50 is received in a state where the second sub-CPU 13 is not in the standby state, for example, the main CPU 11 displays a message screen 80 including a message indicating a notification that it is a waiting time such as "Please Wait" or "WAITING" as illustrated in FIG. 8A, instead of the output destination selection screen 60 illustrated in FIG. 5B. The message screen 80 is a screen that does not include icons and buttons and does not receive user operations.

When the second sub-CPU 13 is not in the standby state, for example, during execution of the HP detection control, the reading engine 16 cannot immediately start the reading operation. As described above, the HP detection control may take a certain amount of time. When the second sub-CPU 13 is not in the standby state, the main CPU 11 causes the user IF 17 to display the message screen 80 to notify the user that the image processing device is in a waiting state, thereby reducing the anxiety of the user while the reading cannot be started.

After the message screen 80 is displayed, the main CPU 11 determines again whether the second sub-CPU 13 is in the standby state (S223). When determining that the second sub-CPU 13 is not in the standby state (S223: NO), the main CPU 11 continues to display the message screen 80.

Meanwhile, when determining that the second sub-CPU 13 is in the standby state (S223: YES), the main CPU 11 hides the message screen 80 (S224) and can execute the operation including reading. As the second sub-CPU 13 is in the standby state, for example, the main CPU 11 hides the message screen 80 illustrated in FIG. 8A, displays the output destination selection screen 60 illustrated in FIG. 5B, and allows an operation related to reading to be received. That is, the main CPU 11 waits for the second sub-CPU 13 to enter the standby state, and can receive an operation related to execution of reading. As a result, it is possible to avoid receiving a reading instruction even though reading cannot be started immediately.

After S224 or when determining that the second sub-CPU 13 is in the standby state (S221: YES), the main CPU 11 executes the operation including the reading operation based on the instruction received in S212 or an execution instruction of the reading received on the screen displayed after S224 (S231).

For example, after displaying the output destination selection screen 60 and receiving the selection of the output destination in S224, the main CPU 11 displays the execution instruction screen 70 including the execution button 71 (FIG. 5C), and sends a reading instruction to the second sub-CPU 13 when receiving an operation on the execution button 71. When being in the standby state, the second sub-CPU 13 can cause the reading engine 16 to perform reading in accordance with the instruction from the main CPU 11.

In a case where the second sub-CPU 13 is not in the standby state, the main CPU 11 may be configured to receive selection on the output destination selection screen 60 and various settings on the execution instruction screen 70, and may not receive an operation on the execution button 71. For example, after receiving the selection of the output destination, the main CPU 11 may display a message screen 90 including an execution button 91 incapable of receiving an operation as illustrated in FIG. 8B or an execution instruction screen not including an execution button, instead of the execution instruction screen 70 illustrated in FIG. 5C. Alternatively, when receiving an operation on the execution button 71 on the execution instruction screen 70, the main CPU 11 may display a message indicating that execution is not allowed. In the message screen 90, an operation on a button other than the execution button 91 may be receivable.

Meanwhile, when determining that the instruction of the user received on the home screen 50 is an instruction not including the reading operation (S212: other than reading), the main CPU 11 executes the instructed operation (S232). For example, in a case where the instruction of the user is an instruction for various settings, or communication with an external device, the main CPU 11 can execute the instruction even if the second sub-CPU 13 is not in the standby state. In a case where the instruction of the user is an instruction includes a printing operation and the first sub-CPU 12 is not in the standby state, the main CPU 11 may display the message screen as illustrated in FIG. 8A.

After S231 or S232, or when determining that the user operation is not received (S211: NO), the main CPU 11 determines again whether both the first sub-CPU 12 and the second sub-CPU 13 are in the standby state (S203). When determining that both the first sub-CPU 12 and the second sub-CPU 13 are in the standby state (S203: YES), that is, after the first sub-CPU activation processing and the second sub-CPU activation processing are completed, the main CPU 11 ends the sub-CPU monitoring processing, returns to the main CPU activation processing illustrated in FIG. 3, and enters the standby state.

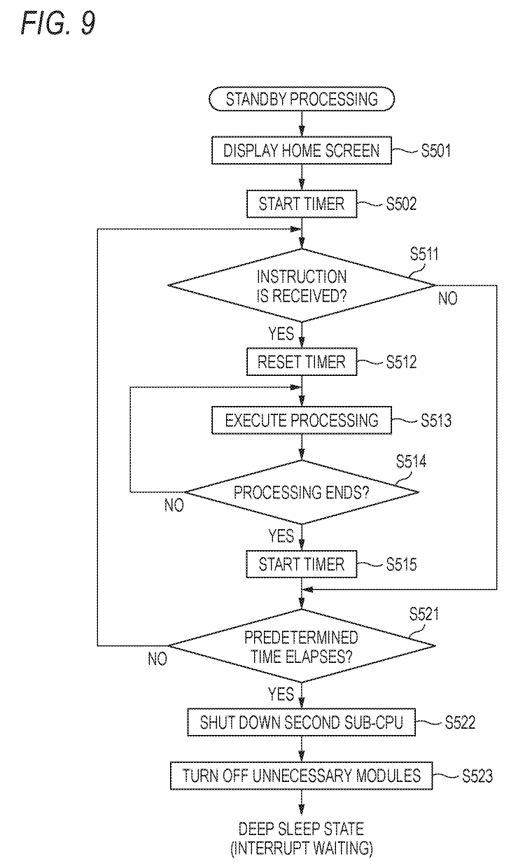

Next, a procedure of standby processing will be described with reference to the flowchart illustrated in FIG. 9. The standby processing is executed by the main CPU 11 after the main CPU activation processing ends and the main CPU 11 enters the standby state.

In the standby state, for example, the main CPU 11 causes the user IF 17 to display the home screen 50 illustrated in FIG. 5A (S501), and allows the user operation to be received. The main CPU 11 is configured to receive data from an external device via the communication IF 14. Further, the main CPU 11 starts a timer for determining a timing to transition to the deep sleep state (S502).

Then, the main CPU 11 determines whether any instruction is received by a user operation on the user IF 17 or data reception from an external device (S511). When determining that an instruction is received (S511: YES), the main CPU 11 resets the timer started in S502 (S512). Further, the main CPU 11 executes processing based on the received instruction (S513).

For example, when the received instruction is a reading instruction, the main CPU 11 instructs the second sub-CPU 13 to drive the reading engine 16 and execute reading. For example, in a case where the received instruction is a printing instruction, the main CPU 11 instructs the first sub-CPU 12 to drive the print engine 15 and execute printing. Then, the main CPU 11 determines whether the processing based on the received instruction ends (S514).

In a case where the processing based on the received instruction ends (S514: YES), that is, in a case where the state is not any of during data reception, during operation reception, during reading operation, and during printing operation, the main CPU 11 starts the timer (S515).

After S515, or when determining that an instruction such as a user operation or data reception is not received (S511: NO), the main CPU 11 determines whether a predetermined time elapses (S521). The predetermined time is a standby time until a transition to the deep sleep state. When determining that the predetermined time does not elapse (S521: NO), the main CPU 11 proceeds to S511, and repeats the determination of S511 and S521 until any instruction is received or the predetermined time elapses.

When determining that the predetermined time elapses (S521: YES), the main CPU 11 shuts down the second sub-CPU 13 (S522). Further, the main CPU 11 stops the supply of power to unnecessary modules, that is, modules not used in the deep sleep state (S523). As a result, the MFP 1 enters the deep sleep state and enters an interrupt waiting state in which only an interrupt such as data reception or a user operation can be received.

The MFP 1 according to the present embodiment does not stop the first sub-CPU 12 even when transitioning to the deep sleep state. When the first sub-CPU 12 includes an OS, the main CPU 11 may shut down the first sub-CPU 12 when transitioning to the deep sleep state.

The MFP 1 may have a sleep state other than the deep sleep state. For example, there may be a heater sleep state in which power supply to a heater of the print engine 15 is stopped and a panel sleep state in which display of the user IF 17 is stopped. When determining that the time for transitioning to each sleep state elapses in S521, the main CPU 11 may transition to the corresponding sleep state and further determine whether a predetermined time until the transition to the deep sleep state elapses.

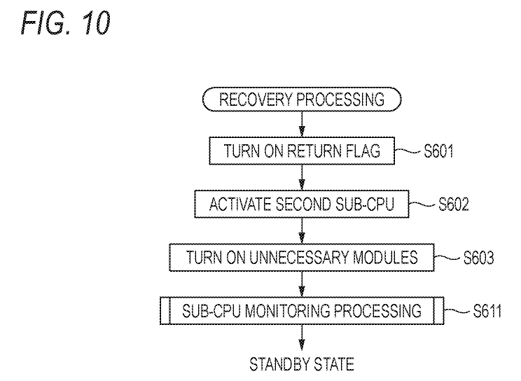

Next, a procedure of the recovery processing will be described with reference to the flowchart illustrated in FIG. 10. The recovery processing is executed by the main CPU 11, for example, in a case where an interrupt such as data reception or a user operation is received after the main CPU 11 determining YES in S521 of the standby processing and entering the deep sleep state.

When receiving an interrupt in the deep sleep state, the main CPU 11 turns on the return flag 241 (see FIG. 1) (S601) and activates the second sub-CPU 13 (S602). In the deep sleep state, the second sub-CPU 13 is shut down, and the main CPU 11 activates the second sub-CPU 13 by releasing the reset of the second sub-CPU 13. As a result, the second sub-CPU 13 starts executing the second sub-CPU activation processing (see FIG. 7).

The ON of the return flag 241 is information indicating that the second sub-CPU 13 is activated by return from the deep sleep state. The second sub-CPU 13 reads the return flag 241 in the second sub-CPU activation processing and determines whether the return flag 241 is ON (S411 in FIG. 7). Since the return flag 241 is turned on in S601 of the recovery processing, the second sub-CPU 13 determines YES in S411 and does not execute the HP detection control.

Even when the job including the ADF reading or the FB reading is executed before the transition to the deep sleep state, the main CPU 11 determines that the processing does not end while the CIS 161 is moved (NO in S514 of FIG. 9). That is, after the CIS 161 is positioned at the reference position HP, the main CPU 11 shuts down the second sub-CPU 13 (S522) and transitions to the deep sleep state. Therefore, it is not necessary to execute the HP detection control when returning from the deep sleep state.

The HP detection control requires a certain amount of time. Since the HP detection control is not executed when returning from the deep sleep state, the second sub-CPU 13 can end the second sub-CPU activation processing early. Therefore, the MFP 1 can execute the reading operation early.

Although the return flag 241 is stored in the NVRAM 24, the return flag 241 may be stored in a storage area of the RAM 22 accessible by the second sub-CPU 13. The return flag 241 is deleted by turning off the power when being stored in the RAM 22, so that the step of turning off the return flag 241 of S112 of the main CPU activation processing becomes unnecessary. Meanwhile, the return flag 241 is reliably turned off by being stored in the NVRAM 24 and turned off in the main CPU activation processing. In S112 of the main CPU activation processing, the main CPU 11 may delete the return flag 241.

Then, the main CPU 11 turns on each module turned off in S523 of the standby processing (S603). Further, the main CPU 11 executes the sub-CPU monitoring processing illustrated in FIG. 4 (S611). When both the first sub-CPU 12 and the second sub-CPU 13 enter the standby state, the main CPU 11 enters the standby state.

The timing for turning on the return flag 241 may be before the transition to the deep sleep state. Specifically, the main CPU 11 may turn on the return flag 241 after determining YES in S521 of the standby processing illustrated in FIG. 9 and before entering the deep sleep state. In this case, S601 of the recovery processing is unnecessary.

As described above in detail, the MFP 1 according to the present embodiment causes the main CPU 11 and the second sub-CPU 13 to execute the respective activation processing when the power is turned on. Specifically, by activating the second sub-CPU 13 in the main CPU activation processing (see FIG. 3) executed by the main CPU 11 (S113), the OS processing (S122) executed by the main CPU 11 or the processing (S124) executed by the main CPU program 33, and the second sub-CPU activation processing (see FIG. 7) executed by the second sub-CPU 13 are performed in parallel. Therefore, the activation time can be expected to be shortened as compared with a case in which the activation processing executed by the main CPU 11 and the activation processing executed by the second sub-CPU 13 are sequentially performed. Further, the main CPU 11 does not receive an operation related to reading on the user IF 17 until the activation processing executed by the second sub-CPU 13 is completed. As a result, it is avoided that the reading instruction is received even though the reading cannot be started immediately.

In the MFP 1 according to the present embodiment, when the power is turned on, the second sub-CPU 13 is caused to execute the initial control of the reading engine 16, for example, the activation processing including the HP detection control, so that the reading engine can be brought into an appropriate state. Meanwhile, at the time of returning from the deep sleep state to the standby state, since the initial control of the reading engine 16 is completed and there is a high possibility that the CIS 161 is positioned at the reference position HP, the second sub-CPU 13 is caused to execute the activation processing not including the HP detection control. This increases the possibility that the activation processing of the second CPU due to the return from the deep sleep state is completed early and the reading can be started early.

The present embodiment is merely an example, and does not limit the present invention. Therefore, various improvements and modifications can be naturally made to the technique disclosed in the present specification without departing from the gist of the present invention. For example, the image processing device is not limited to the MFP 1, and may be any device having an image reading function, such as a copying machine or a FAX device.

For example, in the embodiment, the second sub-CPU 13 includes the OS, but may not include the OS. In addition, the first sub-CPU 12 does not include the OS, but may include the OS.

Further, for example, the illustrated message images are merely examples, and the present invention is not limited thereto. For example, the displayed message is not limited to a message prompting the user to wait, and may be a message indicating that the reading engine 16 is waiting to activate.

In the embodiment, the reading start position PBs for FB reading is positioned in front of the stop position PA for ADF reading, but the present invention is not limited thereto. The reading start position PBs may be the same position as the stop position PA for ADF reading or may be behind the stop position PA for ADF reading.

Further, in the embodiment, the main CPU 11 periodically acquires the state information from the first sub-CPU 12 and the second sub-CPU 13 in S202 of the sub-CPU monitoring processing to determine whether the first sub-CPU 12 and the second sub-CPU 13 are in the standby state, but the main CPU 11 may be notified when the first sub-CPU 12 and the second sub-CPU 13 are in the standby state.

Further, in the embodiment, after the main CPU 11 ends its own initial processing, even if at least one of the first sub-CPU 12 and the second sub-CPU 13 is not in the standby state, the main CPU 11 displays the home screen 50 (FIG. 5A) and receives the operation (S201 of the sub-CPU monitoring processing illustrated in FIG. 4), but the prevent invention is not limited thereto. For example, the main CPU 11 may display the message screen 80 (FIG. 8A) until both the first sub-CPU 12 and the second sub-CPU 13 are in the standby state. Alternatively, after displaying the home screen 50, the main CPU 11 may not receive an operation on the displayed home screen 50 until both the first sub-CPU 12 and the second sub-CPU 13 are in the standby state.

Further, in the embodiment, when the MFP 1 is powered on, the main CPU 11 is first powered on, and the main CPU 11 releases the reset, whereby the first sub-CPU 12 and the second sub-CPU 13 are powered on, but the present invention is not limited thereto. For example, the main CPU 11 and the second sub-CPU 13 may be powered on when the MFP 1 is powered on.

Further, in the embodiment, in the deep sleep state, the main CPU 11 receives the interrupt, and the second sub-CPU 13 is activated by the reset release executed by the main CPU 11, but the second sub-CPU 13 may also be able to receive the interrupt. In this case, the second sub-CPU 13 may execute the HP detection control when being activated by the reset release executed by the main CPU 11, and may not execute the HP detection control when being activated by receiving the interrupt.

In the embodiment, the main CPU 11 notifies the second sub-CPU 13 of the return from the deep sleep state by turning on the return flag 241, but may directly notify the second sub-CPU 13 of the return. For example, when the power is turned on, the main CPU 11 may send the execution instruction of the HP detection control to the second sub-CPU 13 after activating the second sub-CPU 13.

In the present embodiment, a part of the boot loader 31 is compressed and stored, and the compressed part is decompressed and loaded into the SRAM 23 and executed, but the present invention is not limited to this configuration. For example, the boot loader 31 may decompress the compressed part and load the decompressed part into the RAM 22. Further, the boot loader 31 may not have a compressed part, and in this case, the main CPU 11 may read the boot loader 31 from the ROM 21 and operate. However, when the boot loader 31 is compressed and stored, the size is small and the load of the ROM 21 is reduced. Further, since the processing speed of reading from the SRAM 23 or the RAM 22 is higher than that of reading from the ROM 21, it is preferable to compress a part of the boot loader 31, store the compressed part in the ROM 21, decompress the decompressed part, load the decompressed part into the SRAM 23 or the RAM 22, and execute the processing.

Further, for example, the OS 32 is not limited to Linux kernel, and may be RTOS or Windows Embedded. Further, the application programs operating on the OS 32 are not limited to the main control program 331 and the RIP control program 332, and may be other application programs.

In any flowchart or sequence diagram disclosed in the embodiment, an execution order of a plurality of processing in any plurality of steps can be freely changed or can be executed in parallel within a range in which no contradiction occurs in processing content.

The processing disclosed in the embodiments may be executed by hardware such as a single CPU, a plurality of CPU, and an ASIC, or a combination thereof. In addition, the processing disclosed in the embodiments can be implemented in various modes such as a recording medium in which a program for executing the processing is recorded, or a method.

What is claimed is:

1. An image processing device comprising:
a first CPU;
a second CPU;
a reading engine; and
a user interface,
wherein the first CPU is configured to control the user interface,
the second CPU is configured to control the reading engine,
in a case where the image processing device is powered on:
the first CPU executes first activation processing that is activation processing of the first CPU;
the second CPU executes second activation processing that is activation processing of the second CPU including initial control of the reading engine;
in a case where the second activation processing is completed, the second CPU is configured to cause the reading engine to perform reading in accordance with an instruction from the first CPU;
in a case where the first activation processing is completed, the first CPU confirms whether the second activation processing executed by the second CPU is completed, and the first CPU is configured:
not to allow at least an operation related to reading among operations on the user interface to be received until completion of the second activation processing is confirmed; and
to allow the operation related to reading to be received, in a case where the completion of the second activation processing is confirmed; and
in a case where the first CPU sends a reading instruction to the second CPU in accordance with the operation related to reading after the operation related to reading on the user interface is allowed to be received, the second CPU causes the reading engine to perform reading in accordance with the reading instruction from the first CPU.

2. The image processing device according to claim 1,
wherein after the first activation processing is completed and until the completion of the second activation processing is confirmed, the first CPU does not allow an operation on the user interface to be received and causes the user interface to provide a notification indicating a waiting time, and in a case where the completion of the second activation processing is confirmed, the first CPU ends the notification and allows the operation on the user interface to be received.

3. The image processing device according to claim 1,
wherein the first CPU is configured to cause the user interface to display a plurality of icons, the plurality of icons including a specific icon related to reading,
the operation related to reading on the user interface is an operation on the specific icon related to reading, and
the first CPU is configured not to receive the operation on the specific icon related to reading until the completion of the second activation processing is confirmed.

4. The image processing device according to claim 1,
wherein the reading engine includes a reading sensor,
in a case where causing the reading engine to perform reading, the second CPU moves the reading sensor positioned at a standby location to a reading location and causes the reading sensor positioned at the reading location to perform reading,
the initial control of the reading engine includes sensor placement processing of placing the reading sensor at the standby location, and
the first CPU is configured to allow the operation related to reading to be received, in a case where the first activation processing is completed and the completion of the second activation processing including the sensor placement processing is confirmed.

5. The image processing device according to claim 4,
wherein the second CPU is configured to, every time reading executed by the reading engine is completed, place the reading sensor positioned at the reading location at the standby location, and in a case where the image processing device is powered off while the reading sensor is positioned at the reading location, the reading sensor is allowed to remain at the reading location without being placed at the standby location, and
the first CPU is configured to allow the operation related to reading to be received, in a case where the first activation processing is completed and the completion of the second activation processing including the sensor placement processing of placing the reading sensor remaining at the reading location at the standby location is confirmed.

6. The image processing device according to claim 5,
wherein a time required for the sensor placement processing is allowed to be longer than a time required for the first activation processing executed by the first CPU, and
the first CPU is configured to allow the operation related to reading to be received, in a case where the first activation processing is completed and the completion of the second activation processing including the sensor arrangement processing is confirmed.

7. The image processing device according to claim 1, further comprising:
a third CPU; and
a print engine,
wherein the third CPU is configured to control the print engine,
in a case where the image processing device is powered on:
the third CPU executes third activation processing that is activation processing of the third CPU including initial control of the print engine;
in a case where the third activation processing is completed, the third CPU is allowed to cause the print engine to perform printing in accordance with an instruction from the first CPU;
in a case where the first activation processing is completed, the first CPU does not confirm whether the third activation processing executed by the third CPU is completed, and the first CPU is configured:
not to allow at least the operation related to reading among operations on the user interface to be received until the completion of the second activation processing is confirmed; and
to allow the operation related to reading and an operation related to printing to be received, in a case where the completion of the second activation processing is confirmed; and
in a case where the first CPU sends a printing instruction to the third CPU in accordance with the operation related to printing after the operation related to printing on the user interface is allowed to be received, the third CPU causes the print engine to perform printing in accordance with the printing instruction from the first CPU.

8. The image processing device according to claim 1, further comprising:
a first memory that is a nonvolatile memory; and
a second memory that is volatile memory,
wherein the first memory is configured to store a boot program, a system program, and a reading program, the system program and the reading program being compressed and stored in the first memory,
in a case where the image processing device is powered on:
the first CPU decompresses the reading program in the first memory and writes the decompressed reading program in the second memory in accordance with the boot program;
the second CPU starts the second activation processing including the initial control of the reading engine, in accordance with the reading program;
after writing the reading program in the second memory, the first CPU, while the second CPU performs the initial control of the reading engine, decompresses the system program in the first memory and writes the decompressed system program in the second memory in accordance with the boot program, and starts the first activation processing in accordance with the system program; and
in a case where the first activation processing is completed and the completion of the second activation processing is confirmed, the first CPU allows the operation related to reading to be received.

9. The image processing device according to claim 1,
wherein in a case where the image processing device is powered on:
the first CPU is powered on, and the first activation processing is executed as the first CPU is powered on,
in a case where the first CPU is powered on:
the second CPU is powered on, and the second activation processing that is the activation processing of the second CPU including the initial control of the reading engine is executed as the second CPU is powered on;
in a case where the first activation processing is completed, the first CPU confirms whether the second activation processing executed by the second CPU is completed, and the first CPU is configured:
not to allow at least the operation related to reading among operations on the user interface to be received until the completion of the second activation processing is confirmed; and
to allow the operation related to reading to be received, in a case where the completion of the second activation processing is confirmed; and
in a case where the first CPU sends the reading instruction to the second CPU in accordance with the operation related to reading after the operation related to reading on the user interface is allowed to be received, the second CPU causes the reading engine to perform reading in accordance with the reading instruction from the first CPU.
